(19) United States
(12) Patent Application Publication
(10) Pub. No.: US 2024/0375496 A1
(43) Pub. Date: Nov. 14, 2024

(54) ARRANGEMENT FOR MOVING A COVER FOR A VEHICLE ROOF AND VEHICLE ROOF

(71) Applicant: Webasto SE, Stockdorf (DE)

(72) Inventor: Nikolaus Georg EGER, Stockdorf (DE)

(21) Appl. No.: 18/657,355

(22) Filed: May 7, 2024

(30) Foreign Application Priority Data
May 9, 2023 (DE) 102023112161.8

(51) Int. Cl. B60J 7/12

(52) U.S. Cl. CPC B60J 7/12

(57) ABSTRACT

An arrangement for moving a cover for a vehicle roof has a guide rail which extends in a longitudinal direction, and a cover support which can be connected to the cover. The cover support has a first cover support rail and a second cover support rail, wherein the first cover support rail has a first rail end on which the cover support is guided in the guide rail and wherein the second cover support rail can be rigidly fastened to the cover. In a first state, the first cover support rail and the second cover support rail are locked together so that a movement in the longitudinal direction can be transferred from the second cover support rail to the first cover support rail. In a second state, the first cover support rail and the second cover support rail can be displaced relative to one another in the longitudinal direction.

### CROSS-REFERENCE TO RELATED APPLICATION

This application claims the benefit of German Patent Application no. 102023112161.8 filed May 9, 2023, which is incorporated herein by reference in its entirety.

### TECHNICAL FIELD

An arrangement for moving a cover for a vehicle roof is specified, in particular for a movable cover for closing a vehicle roof opening of the vehicle roof. A vehicle roof for a motor vehicle is also specified, in particular a vehicle roof which has an arrangement described herein.

### BACKGROUND

Arrangements with a moveable cover for a vehicle roof can be designed as a so-called externally guided sliding roof, as described for example in DE 197 13 347 C2. Alternatively, it is also possible to design the vehicle roof as a so-called spoiler roof, as described for example in DE 10 2012 106 545 A1.

### SUMMARY

It is desirable to specify an arrangement for a vehicle roof which permits a reliable operation. It is also desirable to specify a vehicle roof which permits a reliable operation.

According to at least one embodiment, an arrangement for a vehicle roof is specified. The arrangement is configured to move a cover for the vehicle roof. The arrangement has a guide rail. The guide rail extends so as to be longitudinally extended in a longitudinal direction. The arrangement has a cover support. The cover support can be connected to the cover. The cover support has a first cover support rail. The cover support has a second cover support rail. The first cover support rail has a first rail end. The cover support is guided in the guide rail on the first rail end. The second cover support rail can be rigidly fastened to the cover. In a first state, the first cover support rail and the second cover support rail are locked together. In the first state, the two cover support rails are locked together so that a movement in the longitudinal direction can be transferred from the second cover support rail to the first cover support rail. In a second state, the first cover support rail and the second cover support rail can be displaced relative to one another in the longitudinal direction.

The cover support has the second cover support rail which, for example, can be screwed to the cover or in a ready-for-use state is rigidly connected to the cover. In the ready-for-use state, the cover and the second cover support rail are not movable relative to one another. The cover is moved by the movement of the second cover support rail. The first cover support rail is guided in the guide rail and thus is supported in the guide rail. The cover is supported on the guide rail by means of the second cover support rail and the first cover support rail. In the second state, the second cover support rail is displaceable along the first cover support rail.

It is possible to lock the first cover support rail to the guide rail and to displace the second cover support rail further relative to the guide rail. In particular, in the first state the first cover support rail and the second cover support rail are displaceable together relative to the guide rail. In the second state, only the second cover support rail is displaceable relative to the guide rail.

The two-part cover support with the first and the second cover support rail permits a greater opening width in an open state. The second cover support rail can be slid relatively far to the rear over a fixed vehicle roof part of the vehicle roof and thus open up a relatively large part of the roof opening of the vehicle roof. However, a reliable support of the cover is possible by means of the first cover support rail, even with a large opening width. In particular, installation space can be efficiently used or no additional installation space is required.

During operation, the first cover support rail is displaced to a lesser extent than the second cover support rail. The movement of the first cover support rail is limited to a portion of the total opening path. Thus by means of the first cover support rail it is possible to implement a sufficient spacing between the support points of the cover support. The second cover support rail is displaceably arranged on the first cover support rail in a manner which is comparable to a drawer slide. The second cover support rail is displaceable further to the rear relative to the first cover support rail in order to achieve a large opening width.

According to at least one further embodiment, in the second state the first cover support rail is fixedly held relative to the guide rail. In the second state, a movement between the first cover support rail and the guide rail is blocked by means of a locking mechanism. In the first state, a relative movement is possible between the first cover support rail and the guide rail in the longitudinal direction. In the second state, the first cover support rail and the guide rail are immovably coupled.

According to at least one embodiment, the first cover support rail is guided in the second cover support rail. The second cover support rail has, for example, a slide track for the first cover support rail. The arrangement of the first cover support rail at least partially in the second cover support rail permits a reliable support of the second cover support rail on the guide rail and an arrangement of the two cover support rails which is efficient in terms of installation space.

According to at least one embodiment, the arrangement has a drive lever. The drive lever is displaceably guided in the guide rail in the longitudinal direction. The drive lever is coupled to the second cover support rail. The second cover support rail is displaceable in the longitudinal direction by means of the drive lever. In particular, the second cover support rail and the drive lever are connected by means of a drive lever joint such that a pivoting of the drive lever is possible relative to the second cover support rail. A relative movement between the second cover support rail and the drive lever is, in particular, blocked in the longitudinal direction.

The drive lever is coupled to a drive, for example, at its end facing away from the second cover support rail. Starting from a closed position, the drive lever is displaced along the guide rail and also moves the first cover support rail and the second cover support rail which are latched together in the first state. In the second state, the second cover support rail is displaceable by means of the drive lever relative to the first cover support rail in the longitudinal direction

According to at least one embodiment, the arrangement has a deployment lever. The deployment lever is fixedly coupled to the guide rail. The deployment lever is pivotable relative to the guide rail. The cover support is movable, in particular, in a height direction by pivoting the deployment lever. For example, a rear edge of the cover support is pivotable by means of the deployment lever, in order to permit a so-called tilted position of the cover. In the tilted position, the rear edge of the cover is lifted relative to the closed position. The front edge of the cover is not lifted or only slightly lifted. The deployment lever is pivotable relative to the guide rail and, in particular, not displaceable in the longitudinal direction of the guide rail. Thus the arrangement is configured, for example, for a so-called spoiler roof. The deployment lever can also be denoted as the rear deployment lever.

According to at least one embodiment, the deployment lever is configured to be in engagement with the first cover support rail. The deployment lever is configured to lift and lower the first cover support rail. In the first state, the first cover support rail is displaceable relative to the deployment lever in the longitudinal direction. In the second state, the first cover support rail is rigidly held relative to the guide rail in the longitudinal direction, so that the deployment lever and the first cover support rail are also immovably held relative to one another in the longitudinal direction. In the second state, the second cover support rail is displaceable relative to the deployment lever in the longitudinal direction.

According to at least one embodiment, the second cover support rail has a first slide track. The second cover support rail has as second slide track. The first slide track and the second slide track are arranged adjacent to one another in a transverse direction. The transverse direction is oriented transversely to the longitudinal direction, for example perpendicularly to the longitudinal direction. The deployment lever is guided in the first slide track and the first cover support rail is guided in the second slide track. By means of the slide tracks arranged adjacent to one another, it is possible to implement the different movement sequences of the first cover support rail and the second cover support rail relative to one another, relative to the deployment lever and relative to the guide rail in the longitudinal direction. Moreover, substantially no additional installation space is required in the height direction Z.

According to at least one embodiment, in the second state the drive lever and the deployment lever are arranged adjacent to one another in the transverse direction. The guide rail has a lever track in which the drive lever is guided. The lever track has a path so that the drive lever can be guided adjacent to the deployment lever in the longitudinal direction. Thus the drive lever can be displaced relatively far to the rear.

This permits a large opening width and a reliable support.

According to at least one embodiment, the arrangement has a drive motor. The drive lever and the deployment lever are coupled to the drive motor. The coupling is configured such that the displacement of the drive lever and the pivoting of the deployment lever can be driven by the drive motor. Thus it is possible, for example, to drive the drive lever and the deployment lever by means of a single drive motor, in particular by means of a single electric motor.

According to further exemplary embodiments, two or more drive motors are provided in order to drive the drive lever and the deployment lever separately.

According to at least one embodiment, a vehicle roof for a motor vehicle has an arrangement according to at least one of the embodiments described herein. The vehicle roof has the cover. The second cover support rail is rigidly coupled to the cover. For example, the second cover support rail and the cover are rigidly screwed together, in order to block a relative movement in the longitudinal direction. The cover is thus fastenable to the guide rail by means of the second cover support rail and the first cover support rail. In the first state, the cover, the first cover support rail and the second cover support rail are moved together relative to the guide rail in the longitudinal direction. In the second state, the cover and the second cover support rail are moved, in particular displaced, together relative to the first cover support rail and the guide rail in the longitudinal direction.

### BRIEF DESCRIPTION OF DRAWINGS

Further advantages, features and developments are found in the following examples which are described in connection with the figures. Elements which are the same or have the same function can be provided with the same reference signs in all of the figures.

In the figures:

FIG. 1 shows a schematic view of a part of a vehicle according to an exemplary embodiment, and

FIGS. 2 to 4 show in each case schematic views of an arrangement according to an exemplary embodiment in different views.

### DETAILED DESCRIPTION

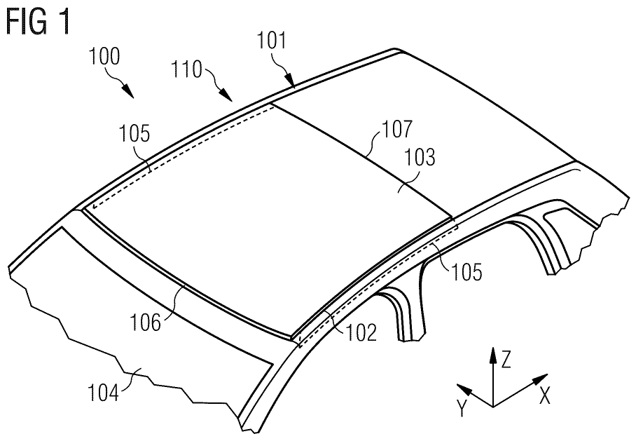

FIG. 1 shows a schematic view of a vehicle roof 101 of a vehicle 100. The vehicle roof 101, in particular, is part of the motor vehicle 100, for example part of a passenger motor vehicle. The vehicle roof 100 has an arrangement 110. The arrangement 110 has a cover 103. The cover 103 serves for closing a roof opening 102. The roof opening 102 is configured in the vehicle roof 101. The roof opening 102 can be closed in a closed position and at least partially opened up in an open position by displacing the cover 103 in a longitudinal direction X. To this end, the cover 103 is displaceable in the longitudinal direction X and a height direction Z oriented transversely thereto, between the closed position which is shown in FIG. 1 and an open position, relative to a fixed roof of the vehicle roof 101. For the closure, the cover is moved counter to the longitudinal direction X.

The cover 103 has a front edge 106 and a rear edge 107. The rear edge 107 is arranged opposite the front edge 106 of the cover 103 in the longitudinal direction X. The front edge 106 of the cover 103 faces a windshield 104 of the vehicle 100.

The arrangement 110 has two guide rails 105. The guide rails 105 are longitudinally extended in each case in the longitudinal direction X. The guide rails 105 are arranged in each case in the transverse direction Y adjacent to the roof opening 102. In the transverse direction Y the guide rails 105 are coupled, for example, to a body of the vehicle 100.

Positional information or directional information which is used, such as rear or front, relates to the vehicle longitudinal direction X. The vehicle longitudinal direction can also be denoted as the horizontal direction or X-direction of the mathematical right-handed system. The lifting or deployment of the cover 103 takes place in the height direction Z which can also be denoted as the vertical direction. Correspondingly, positional information or directional information such as top or bottom refers to the height direction Z. The region of the front edge 106 of the cover 103 (front region of the cover 103), for example, is to be understood as the region facing the windshield 104 starting from a centre of the cover in the longitudinal direction X. The longitudinal direction X, the transverse direction Y and the height direction Z are in each case, in particular, perpendicular to one another.

The arrangement 110, in particular on both sides of the roof opening 102, is constructed the same, in particular mirror-symmetrically and corresponding to one another. One side is described hereinafter and the opposing side in the transverse direction X is correspondingly configured to be the same.

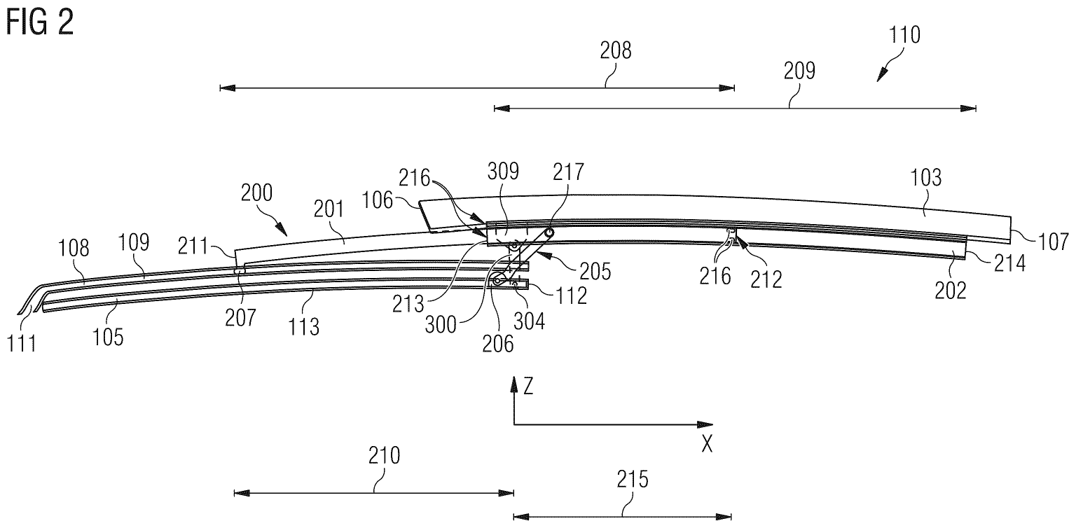

FIG. 2 shows the arrangement 110 in the open position of the cover 103. The cover 103 is displaced to the rear relative to the guide rail 105 in the longitudinal direction X, so that the roof opening 102 is opened up to a maximum. The cover 103 is thus arranged in the height direction Z largely above the fixed vehicle roof 101.

The cover 103, for example, is a glass cover or a plastics cover. For example, the cover 103 has a lighting functionality and/or a shading functionality and/or a heating functionality and/or a cooling functionality and/or solar cells. The cover 103 can be configured to be relatively heavy, due to the embodiment of the arrangement 110 described in more detail below.

The cover is coupled by means of a cover support 200 to the guide rail 105. The cover support 200 is displaceable relative to the guide rail 105 in the longitudinal direction in order to displace the cover 103 relative to the guide rail 105.

The cover support 200 has a first cover support rail 201 and a second cover support rail 202. The first cover support rail 201 and the second cover support rail 202 together form the cover support 200. The cover support 200 is firstly couplable to the guide rail 105 in order to support the cover 103 on the guide rail 105. To this end, the cover support 200 is also able to be coupled to the cover 103.

The cover 103 is rigidly fixed to the second cover support rail 202. For example, the cover 103 has a so-called cover inner plate which is foamed or adhesively bonded to a flat cover panel. The second cover support rail 202 is fastened to the cover inner plate.

The first cover support rail 201 is held and guided in the guide rail 105. The first cover support rail 201 has a first rail end 211. A guide slider 207 is arranged on the first rail end 211. The guide slider 207 is held and guided in a rail link 108 of the guide rail 105. The guide slider 207 serves as a front support point for the cover 103 and the cover support 200. The first rail end 211 is thus assigned to the front edge 106 and arranged facing away from the rear edge 107 in the longitudinal direction. A spacing in the longitudinal direction X between the first rail end 211 and the front edge 106 can be changed during the movement of the cover in the second state. The first rail end 211 is arranged spaced further apart from the front edge 106 in the open position than in the closed position.

The first cover support rail 201 has a second rail end 212 facing away from the first rail end 211 in the longitudinal direction X. The first cover support rail 201 is guided in the second cover support rail 202, so that the second rail end 212 of the first cover support rail 201 is always arranged in the second cover support rail 202.

The arrangement 110 has a deployment lever 300. The deployment lever is fastened by means of a rotary joint 304 to the guide rail 105. The deployment lever 300 is pivotable relative to the guide rail 105. The deployment lever 300 is fixed in a stationary manner to the guide rail 105 in the longitudinal direction and, in particular, by means of the rotary joint 304. The deployment lever 300 is pivotable between a deployed position shown in FIG. 2 and a pivoted-in position. The deployed position is assigned to the open position of the cover 103 and the pivoted-in position is assigned to the closed position. In the pivoted-in position, the deployment lever 300, in particular, is primarily oriented in the longitudinal direction X. The cover support 200 and the cover 103 are supported by means of the deployment lever 300 on a region on the guide rail 105 assigned to the guide rail end 112.

In the closed position, the rear edge 107 is arranged in the region of the deployment lever 300. Starting from the closed position, the rear edge 107 is lifted by pivoting the deployment lever 300. The deployment lever 300 is, in particular, in engagement with the first cover support rail 201.

The arrangement 110 has a drive lever 205. The drive lever 205 is coupled, in particular, to the second cover support rail 202. The drive lever 205 is held and guided in the guide rail 105 by means of a sliding drive member 206. The sliding drive member 206 is displaceably guided relative to the guide rail 105 in a lever track 113 of the guide rail 105 in the longitudinal direction.

Starting from the closed position, for moving the cover 103 into the open position, the sliding drive member 206 and thus the drive lever 205 are displaced to the rear in the longitudinal direction X. This displacement movement is transferred to the second cover support rail 202. The second cover support rail 202 and the drive lever 205 are coupled together by means of a drive lever joint 217, such that a pivoting of the drive lever 205 is possible relative to the second cover support rail 202. A longitudinal displacement between the drive lever 205 and the second cover support rail 202 is blocked in the longitudinal direction.

In a first movement portion, starting from the closed position, the first cover support rail and the second cover support rail 202 are locked together and/or latched together. Thus the movement of the drive lever 205 is transferred by means of the second cover support rail 202 to the first cover support rail 201.

The guide slider 207 is thus moved along the rail link 108. The rail link 108 has an inclined link region 111 at its front end which is arranged opposing the guide rail end 112 in the longitudinal direction X. A linear link region 109 adjoins thereto. Initially the front edge 106 is lifted by means of the inclined link region 111. Hereinafter a linear displacement is implemented in the longitudinal direction X by means of the linear link region 109. The cover support 200 and, in particular, the first cover support rail 201 in the locked state are displaced together with the second cover support rail 202 relative to the deployment lever 300 in the longitudinal direction X.

In a second movement portion or in a second state, the locking is released between the first cover support rail 201 and the second cover support rail 202. Rather, the first cover support rail 201 is locked to the guide rail 105, so that a longitudinal displacement of the first cover support rail 201 and the guide rail 105 relative to one another is blocked. Thus the first cover support rail 201 is held in the position shown in FIG. 2.

The second cover support rail 202 can be displaced further to the rear relative to the first cover support rail 201, driven by the drive lever 205. The second cover support rail 202 is supported on the first cover support rail 201 and thus on the guide rail 105. Thus the cover 103 can be displaced further to the rear and still can be supported relatively far to the front by means of the first cover support rail 201 and the guide slider 207 arranged at its first rail end 211.

The second cover support rail 202 can be displaced further to the rear relative to the guide rail 105 and the deployment lever 300 until the open position shown in FIG. 2 is reached.

In the open position, the guide slider 207 and the deployment lever 300 are at the first support spacing 210. For example, the first support spacing 210 corresponds to at least a third of a length of the guide rail 105, in particular at least half of the length of the guide rail 105. The length of the guide rail 105 results, in particular, from the spacing of the inclined link region 111 relative to the guide rail end 112 in the longitudinal direction X. The first support spacing 210 corresponds, for example, to at least a third or at least half of the length of the first cover support rail 201 in the longitudinal direction X between the first rail end 211 and the second rail end 212.

In the open position, the first cover support rail 201 protrudes into the second cover support rail 202 at least over the length of a second spacing 215. The second rail end 212 thus can be arranged relatively far to the rear over the fixed region of the vehicle roof 101. Thus the cover 103 is reliably supported on the guide rail 105 due to the second rail end 212 being arranged relatively far to the rear and the first rail end 211 being arranged relatively far to the front. The first rail end 211 and the second rail end 212 are arranged relatively far apart from one another and, in particular, also relatively far removed from the deployment lever 300. Thus in the open position advantageous lever ratios are provided for supporting the cover 103. This permits the positioning of the cover far to the rear in the open position and nevertheless the reliable support and holding of the cover 103.

In the open position, a third rail end 213 of the second cover support rail 202 is arranged in the region of the deployment lever 300. The third rail end 213 can also be denoted as the front end of the second cover support rail 202. In the longitudinal direction X the second cover support rail 202 has a fourth rail end 214 which can also be denoted as the rear end of the second cover support rail 202. The fourth rail end 214 is assigned to the rear edge 107 of the cover. The third rail end 213 is assigned to the front edge 106 of the cover. In the open position, the second rail end 212 of the first cover support rail 201 is arranged between the third rail end 213 and the fourth rail end 214 of the second cover support rail 202 in the longitudinal direction. For example, the second rail end 212 is arranged in a central region between the third rail end 213 and the fourth rail end 214.

The first cover support rail 201 has a longitudinal extent 208. The second cover support rail 202 has a longitudinal extent 209 in the longitudinal direction X.

The longitudinal extent 208 of the first cover support rail 201 is, for example, approximately the same length as the second longitudinal extent 209 of the second cover support rail 202. In the open position, the longitudinal extents 208, 209 overlap, as shown in FIG. 2, so that the third rail end 213 is arranged between the first rail end 211 and the second rail end 212 and the second rail end 212 is arranged between the third rail end 213 and the fourth rail end 214. In the open position, the spacing between the first rail end 211, which forms a front end of the cover support 200, and the fourth rail end 214, which forms a rear end of the cover support 200, is greater than the longitudinal extent 208 and greater than the longitudinal extent 209. A spacing between the first rail end 211 and the fourth rail end 214 can be changed, in particular, and is less in the closed position than in the open position. Thus the overall length of the cover support 200 can be changed due to the displaceability of the two cover support rails 201, 202 relative to one another in the longitudinal direction X.

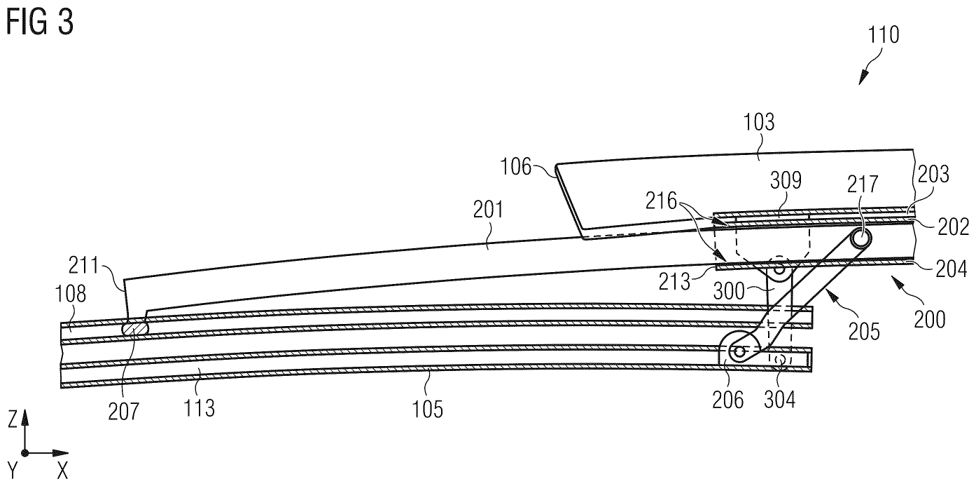

As also shown in FIG. 3, at least one rail slider 216 is arranged on an inner face of the second cover support rail 202. In particular, in each case rail sliders 216 are configured on the third rail end 213 and on the fourth rail end 214. The rail sliders 216 are made, for example, of a plastics or another friction-reducing material. The rail sliders 216 are arranged in each case, in particular, in the height direction Z and/or the transverse direction Y between the first cover support rail 201 and the second cover support rail 202. The rail sliders 216 reduce the friction between the first cover support rail 201 and the second cover support rail 202 so that a low-friction displacement of the two cover support rails 201, 202 relative to one another is possible. Alternatively or additionally, the rail sliders 216 are configured in each case to damp vibrations and/or the transmission of sound. Thus it is possible to reduce noise emissions which are produced, for example, during operation in the open position due to vibrations of the cover 103. These vibrations are damped by means of the rail sliders 216 and thus introduced only to a reduced extent into the guide rail 105 and into the vehicle body.

In FIG. 3 it can also be seen that in the open position the drive lever 205 and the deployment lever 300 are arranged adjacent to one another and intersecting. The drive lever 205 and the deployment lever 300 are arranged offset in the Y-direction. In the longitudinal direction X the deployment lever 300 is substantially oriented in the height direction Z and the drive lever 205 is oriented obliquely thereto. In a projection onto an XY-plane, the rotary joint 304 is arranged in the longitudinal direction X between the sliding drive member 206 and the drive lever joint 217.

The deployment lever 300 is coupled to the cover support 200 by means of a deployment lever slide 309. The second cover support rail 202 and the deployment lever slide 309 are slidably coupled together so that the movement in the longitudinal direction X is possible, but a movement in the height direction Z and a movement in the transverse direction Y between the deployment lever 309 and the second cover support rail 202 is blocked. The deployment lever slide 309 and the deployment lever 300 are pivotably coupled together in order to permit the pivoting of the deployment lever 300 relative to the guide rail 105 and to the cover support 200.

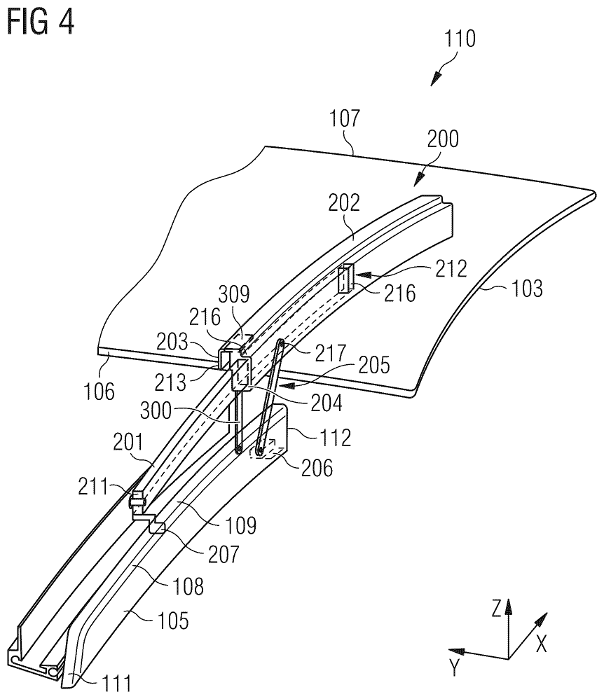

A first slide track 203 and a second slide track 204 of the second cover support rail 202 can be seen in FIG. 4. The two slide tracks 203, 204 are arranged laterally offset to one another in the Y-direction. The two slide tracks 203, 204 primarily extend in each case in the longitudinal direction X. The second cover support rail 202 is thus configured to be wider in the transverse direction Y than the first cover support rail 201.

The first cover support rail 201 is guided in the second slide track 204. The deployment lever 300 and, in particular, the deployment lever slider 309 are guided in the first slide track 203. It is possible that the first slide track 203 and the second slide track 204 are arranged offset to one another in the height direction Z, in particular in order to follow a curvature of the cover 103. For example, the deployment lever slider 309 has a T-shape at its end facing the cover 103. The slide track 203 accordingly has a corresponding profile so that the T-shape of the deployment lever slider 309 can reliably engage in the first slide track 203.

The second slide track 204 has a substantially rectangular cross section which is adapted to an external shape of the first cover support rail 201.

For example, the rear cover slider 216 is fastened to the second rail end 212 of the first cover support rail 201 and moves together with the first cover support rail 201 relative to the second cover support rail 202. On the second cover support rail 202, the front rail slider 216 is fastened, for example, at the third rail end 213 rigidly to the second cover support rail 202.

The first cover support rail 201 moves to a lesser extent than the cover 103 in the longitudinal direction between the closed position and the open position. In the closed position, the cover 103 is moved further to the rear in the longitudinal direction X than the first cover support rail 201. Thus it is possible to implement a sufficient spacing between the guide slider 207 which forms a front support and the deployment lever slider 309 which implements a rear support of the cover support 200 and, in particular, the first cover support rail 201.

For example, in the first state the first cover support rail 201 and the second cover support rail 202 are latched together so that the drive movement of the sliding drive member 206 can be transferred to the first cover support rail 201. It is also possible that the sliding drive member 206 and the guide slider 207 are locked together, so that in the first state the movement in the longitudinal direction can be transferred to the first cover support rail. For example, a drive rod which is selectively coupled to or decoupled from the first cover support 201 is provided to this end. For example, the drive movement is also transferred indirectly or directly to the deployment lever 300, so that the lifting and lowering of the deployment lever 300 is also driven by the drive. To this end, for example, a link mechanism, a drive rod or a further transmission element are also provided.

It is also possible that the arrangement 110 has two or more drives. For example, a drive is provided to move the deployment lever 300. A further drive is provided, for example, in order to move the guide slider 207. A third drive is provided, for example, in order to move the sliding drive member 206. It is also possible to provide only two drives, wherein for example one drive drives both the sliding drive member 206 and the guide slider 207 and the second drive drives the pivoting of the deployment lever 300.

Since in the open position the first rail end 211 can be arranged far in front of the front edge 106 in the longitudinal direction X, greater spacings can be generated between the support points of the cover support 200 on the guide rail 105. In the open position, the sliding drive member 206 is arranged between the first rail end 211 and the second rail end 212 in the longitudinal direction X. In the second state, the sliding drive member 206 can be displaced relative to the guide slider 207 in the longitudinal direction X. The relatively large spacing between the support points of the cover support 200 permits reduced loads at the support points. Thus greater opening widths can be implemented for the cover 103 in the open position. Alternatively or additionally, it is possible to use the cover 103 with larger masses. For example, in the open position the first cover support rail 201 extends along half of its longitudinal extent 208+/−10% outside the second cover support rail 201 and with the remainder of its longitudinal extent 208, i.e. in particular half+/−10%, inside the second cover support rail 202.

The second cover support rail 202 is directly attached to the drive lever 205 so that the length of the guide rail 105 can be expediently utilized in order to slide the sliding drive member 206 and thus the drive lever 205 and thus the second cover support rail 202 and thus the cover 103 in the open position as far as possible to the rear. The arrangement of the sliding drive member 206 and the deployment lever 300 laterally offset in the Y-direction contributes thereto.

### REFERENCE SIGNS

100 Vehicle
101 Vehicle roof
102 Roof opening
103 Cover
104 Windshield
105 Guide rail
106 Front edge
107 Rear edge
108 Rail link
109 Linear link region
110 Arrangement
111 Inclined link region
112 Guide rail end
113 Lever track
200 Cover support
201 First cover support rail
202 Second cover support rail
203 First slide track
204 Second slide track
205 Drive lever
206 Sliding drive member
207 Guide slider
208 Longitudinal extent first cover support rail
209 Longitudinal extent second cover support rail
210 First support spacing
211 First rail end
212 Second rail end
213 Third rail end
214 Fourth rail end
215 Second support spacing
216 Rail slider
217 Drive lever joint
300 Deployment lever
304 First rotary joint
309 Deployment lever slider
x Longitudinal direction
Y Transverse direction
Z Height direction

1. Arrangement for moving a cover for a vehicle roof, having:
a guide rail which extends in a longitudinal direction,
a cover support which can be connected to the cover, wherein the cover support has a first cover support rail and a second cover support rail, wherein the first cover support rail has a first rail end on which the cover support is guided in the guide rail and wherein the second cover support rail can be rigidly fastened to the cover, wherein in a first state the first cover support rail and the second cover support rail are locked together so that a movement in the longitudinal direction can be transferred from the second cover support rail to the first cover support rail, and wherein in a second state the first cover support rail and the second cover support rail can be displaced relative to one another in the longitudinal direction.

2. Arrangement according to claim 1, wherein in the second state the first cover support rail is fixedly held relative to the guide rail.

3. Arrangement according to claim 1, wherein the first cover support rail is guided in the second cover support rail.

4. Arrangement according to claim 1, having
a drive lever which is displaceably guided in the guide rail in the longitudinal direction and which is coupled to the second cover support rail, in order to displace the second cover support rail in the longitudinal direction.

5. Arrangement according to claim 1, having
a deployment lever which is fixedly coupled to the guide rail so that the deployment lever is pivotable relative to the guide rail in order to move the cover support, wherein the cover support is displaceable relative to the deployment lever in the longitudinal direction.

6. Arrangement according to claim 5, wherein the deployment lever is in engagement with the first cover support rail.

7. Arrangement according to claim 5, wherein in the second state the first cover support rail is fixedly held relative to the deployment lever and the second cover support rail is displaceable relative to the deployment lever in the longitudinal direction.

8. Arrangement according to claim 5, wherein the second cover support rail has a first and a second slide track arranged adjacent to one another in a transverse direction, wherein the deployment lever is guided in the first slide track and the first cover support rail is guided in the second guide track, wherein the transverse direction is oriented transversely to the longitudinal direction.

9. Arrangement according to claim 5, wherein in the second state the drive lever and the deployment lever are arranged adjacent to one another in the transverse direction.

10. Arrangement according to claim 9, having a drive motor, wherein the drive lever and the deployment lever are coupled to the drive motor, so that the displacement of the drive lever and the pivoting of the deployment lever can be driven by the drive motor.

11. Vehicle roof, having:
an arrangement according to claim 1,
a cover, wherein the second cover support rail is rigidly coupled to the cover.
